(19) United States
(12) Patent Application Publication
(10) Pub. No.: US 2008/0155871 A1
(43) Pub. Date: Jul. 3, 2008

(54) Home light

(76) Inventors: Wesley G. Parker, Maryville, MO (US); Beth Parker, Maryville, MO (US)

Correspondence Address: Raymond M. Galasso;Galasso & Associates LP, P.O. Box 26503, Austin, TX, 78755-0503, US

(21) Appl. No.: 11/649,013

(22) Filed: Jan. 3, 2007

(51) Int. Cl. G09F 13/06

(52) U.S. Cl. 40/576

(57) ABSTRACT

Home Light is a sign equipped with a backlight and a mechanism for insertion of a set of numbers displaying a home or business address. To use Home Light, a user chooses a location on a house or other structure that is easily viewed from the street and not obscured by any trees, shrubbery or other impediments. He then attaches the sign to the structure in the selected location. The sign is then hard-wired to the structure's electrical system or utilizes another power source to provide power to the backlighting unit and illuminate the numbers.

### CROSS REFERENCE TO RELATED APPLICATIONS

This United States Non-Provisional Patent Application does not claim priority to any United States Provisional Patent applications or any foreign patent applications.

### FIELD OF THE DISCLOSURE

The disclosures made herein relate generally to the household improvement industry. The invention discussed herein is in the general classification of home address signs.

### BACKGROUND

Home and business address numbers are often difficult to read, especially at night. Some home or business address numbers are partially concealed by shrubbery or other impediment. Others can be difficult to view from the street due to distance, size or improper lighting.

An individual's inability to see address numbers has many undesirable consequences. Deliveries may be delayed or terminated when a house or business number cannot be located. Friends may also become lost on the way to certain addresses. More importantly, emergency services may have difficulty locating a house or business.

Currently, most address numbers are either attached directly to the house or edifice or located on a curb. Unfortunately, these numbers often become worn by the outdoor elements and can become difficult to read. Numbers attached directly to a house can also become detached. Unless these numbers are properly illuminated, they may be useless at night even when they have not been deteriorated by the weather or detached from a structure.

Hence, there is a need in the art for a convenient, inexpensive and effective device for illuminating the address of a home or business.

### SUMMARY OF THE DISCLOSURE

Home Light is a sign equipped with a backlight and a channel or other mechanism for insertion of a set of numbers displaying a home or business address.

The principal object of this invention is to provide a device that can be used to display and light the address of a home or business.

Another object of this invention is to provide a device that can be easily installed on a home.

Another object of this invention is to provide an affordable device for prominently displaying an address of a home or business.

Another object of this invention is to provide a device that will permit delivery services to see the address of a home day or night.

Another object of this invention is to provide a device that will protect the address numbers from the weather elements.

Yet another object of the invention is to provide a device that will cause the address of a home to flash when an emergency call has been placed from the house phone.

### BRIEF DESCRIPTION OF THE DRAWINGS

FIG. 1 depicts a perspective view of the preferred embodiment of the present invention.

FIG. 2 depicts a cross-sectional view of the preferred embodiment of the invention cut along the line A-A of FIG. 1.

### DETAILED DESCRIPTION OF THE DRAWINGS

The preferred embodiment of Home Light is comprised of at least some of the following: a rectangular sign with a channel in a front panel for insertion of numbers, a Light Emitting Diode (LED) panel unit to illuminate the numbers inserted into the channel, and a connection to a structure's electrical system to power the LED panel unit.

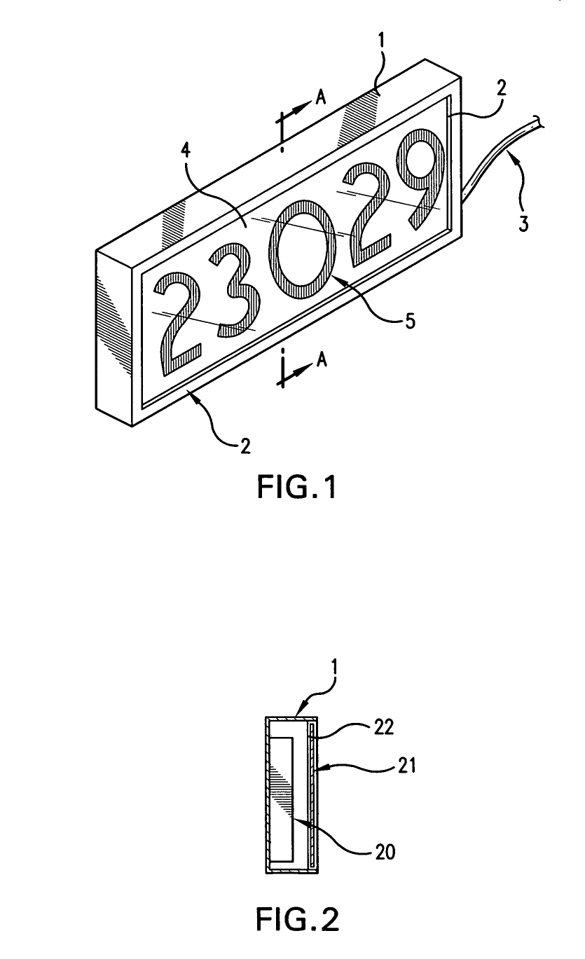

FIG. 1 shows the preferred embodiment of the present invention. A rectangular sign 1 has a transparent front cover 2. The rectangular sign 1 is twenty-four inches in length, ten inches in height, and two inches in depth. The rectangular sign 1 is made of plastic in the preferred embodiment though other materials may also be utilized. Within the rectangular sign 1, an LED panel unit (not pictured) is connected to a structure's electrical system via an insulated wire 3. On the back of the rectangular sign 1, an attaching mechanism of two screws permits the rectangular sign 1 to be easily connected to a house or other structure. A plastic sheet 4 with numbers 5 can be inserted into a channel (not shown) inside the transparent front cover 2. The numbers 5 can either be made of transparent plastic or can simply be cut-outs from the plastic sheet 4 to allow light to pass through them. The area of the plastic sheet 4 surrounding the numbers 5 is opaque to prevent or minimize the passage of light.

FIG. 2 depicts a cross-sectional view of the preferred embodiment of the invention cut along the line A-A of FIG. 1. The LED panel unit 20 can be seen within the rectangular sign 1. The channel 21 for insertion of the plastic sheet can also be seen in the front of the rectangular sign 1 behind the transparent front cover 2. The channel 21 is formed between the front cover 2 and a transparent layer 22 that extends the length of the rectangular sign 1. The front cover 2 and the transparent layer 22 are attached such that the entire front panel can be removed to permit insertion of the plastic sheet inside the channel 21.

To use Home Light, a user chooses a location on a house or other building that is easily viewed from the street and not obscured by any trees, shrubbery or other impediments. He then either uses the screws on the back of the sign or some other attaching mechanism to fasten the sign to the structure in the selected location. The sign is then hard-wired to the structure's electrical system to provide power to the LED panel unit or other backlighting unit. The light transmits through the transparent layer, numbers and front cover but not through the opaque material surrounding the numbers, permitting the numbers to be seen clearly from the street.

In an alternative embodiment of the invention, a battery or solar cell could be utilized to power the LED panel rather than or in addition to a connection to a building's electrical system. Obviously, other sources of light other than an LED panel could also be utilized. Transparent plastic sheets of various colors can also be inserted into the channel with the plastic sheet containing the numbers to permit a user to accessorize the sign to decorate for holidays or special occasions.

In another alternative embodiment of the invention, the sign could also be operatively attached to a building's phone system such that any call placed from that phone system to an emergency number causes the light to blink until it is manually reset via a switch or unplugging/resetting the unit. The switch could be in a variety of accessible locations on the sign such as on the top or on one of the sides.

The materials utilized for Home Light may vary widely but will likely include metals, plastic and electrical components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Home Light can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It should be obvious that the components of the present invention can be of various shapes and sizes. It should also be obvious that the components of the invention can be made of different types of plastics or other suitable materials and can be of any color. Although the channel of the preferred embodiment of this invention is formed between the transparent front cover and a second transparent layer, a variety of methods may be used to sandwich the plastic sheet, including methods not requiring a transparent layer or any mechanism extending the entire length of the sign. For example, the four corners of the inside front cover of the sign may create the channel for insertion of the plastic sheet with small protuberances in each corner. It should also be obvious that there is no limit to the number of numbers that can be included on the plastic sheet and the plastic sheet could also contain letters or other symbols. Therefore, as used herein, a set of numbers means as few as one letter, number or other symbol and can include any amount of letters, numbers or other symbols.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. An address display device comprising:
(a) a sign with a transparent front cover;
(b) a lighting unit within the sign; and
(c) a sheet with a set of numbers that can be inserted into a channel inside the front cover;

2. The device of claim 1 wherein the sign is rectangular.

3. The device of claim 1 wherein the sign is made of plastic.

4. The device of claim 1 wherein the sign is made of metal.

5. The device of claim 1 wherein the lighting unit is an LED panel unit.

6. The device of claim 1 further comprising
a power source for operating the lighting unit.

7. The device of claim 6 wherein the power source is a solar cell.

8. The device of claim 6 wherein the power source is a battery.

9. The device of claim 1 wherein the power source is an electrical system within a structure.

10. The device of claim 1 further comprising
an attaching mechanism on the back of the sign.

11. The device of claim 10 wherein the attaching mechanism is a set of two screws.

12. The device of claim 1 wherein the sheet is plastic and opaque around the set of numbers.

13. The device of claim 1 wherein the channel is between a transparent layer and the transparent front cover.

14. The device of claim 1 wherein the set of numbers is made of transparent plastic.

15. The device of claim 1 wherein the set of numbers is cut out from the plastic sheet.

16. The device of claim 1 further comprising
a colored transparent plastic sheet for insertion in the channel.

17. The device of claim 6 further comprising
a cord attached to the power source and to a phone system of a structure causing the lighting unit to blink when a specific number is dialed on the phone system.

18. The device of claim 17 further comprising
a switch located on the sign to reset the sign after the specific number is dialed.

19. An address display device comprising:
(a) a sign that is rectangular and plastic having a transparent front cover;
(b) an LED panel unit within the sign;
(c) an insulated wire connected to an electrical system of a structure for powering the LED panel,
(d) an opaque plastic sheet with a set of transparent numbers that can be inserted between a transparent layer and the transparent front cover;
(e) a set of screws on the back of the sign;
(f) a cord attached to the electrical system and to a phone system of the structure causing the LED panel to blink when a specific number is dialed on the phone system; and
(g) a switch located on the sign to reset the sign after the specific number is dialed.
